(19) United States
(12) Patent Application Publication
(10) Pub. No.: US 2026/0204963 A1
(43) Pub. Date: Jul. 16, 2026

(54) ROTOR FOR AN ELECTRIC MACHINE WITH A MECHANICAL FIXATION OF ROTOR MAGNETS

(71) Applicant: VALEO EAUTOMOTIVE GERMANY GMBH, Erlangen (DE)

(72) Inventors: Eric JOZEFOWIEZ, Creteil Cedex (FR); Panneerselvam SUNDARARAJAN, Chennai (IN); David MARGUERITTE, Creteil Cedex (FR); Hirubaakaran MOORTHY, Chennai (IN); Alexian BOUTINEAUD, Etaples-sur-Mer (FR); Shishir SATLE, Chennai (IN); Sivasankar MUNI, Chennai (IN)

(73) Assignee: VALEO EAUTOMOTIVE GERMANY GMBH, Erlangen (DE)

(21) Appl. No.: 19/133,529

(22) PCT Filed: Nov. 27, 2023
(86) PCT No.: PCT/EP2023/083238

§ 371 Date: May 28, 2025

(30) Foreign Application Priority Data
Nov. 30, 2022 (DE) 10 2022 131 793.5

(51) Int. Cl. H02K 1/276

(52) U.S. Cl. CPC H02K 1/276

(57) ABSTRACT

A rotor for an electric machine includes a rotor lamination stack having a cavity, and a rotor magnet with a substantially rectangular cross section being arranged in the cavity. At least some of the rotor laminations include a spring tongue, which is unbent and reaches into a space provided for the rotor magnet in the unmounted state of the rotor magnet and which is bent and imposes an oblique force on the same in the mounted state of the rotor magnet based on elastic deformation. The oblique force is directed in an angle (α) of 0°>α>90° to longitudinal sides of the rectangular cross section of the rotor magnet. The stator and rotor may be implemented in an electric machine or a vehicle with the electric machine.

### TECHNICAL FIELD

The invention relates to a rotor for an electric machine, which comprises a rotor lamination stack with a plurality of rotor laminations stacked over another in an axial direction, wherein the rotor laminations form a cavity for a rotor magnet, and which comprises a rotor magnet, which is arranged in said cavity and which has a substantially rectangular cross section. In addition, the invention relates to an electric machine, which comprises a stator and a rotor of the aforementioned kind, which is rotatably arranged relative to the stator. Finally, the invention relates to a vehicle with a drive train comprising an electric machine of the aforementioned kind, which is provided to propel the vehicle.

### BACKGROUND ART

A rotor, an electric machine and a vehicle of the above kinds are basically known in prior art. For example, the rotor can be a permanently excited rotor, in which the rotor magnetic field is generated by a plurality of rotor magnets arranged in the rotor lamination stack. In order to fix the rotor magnets in the rotor lamination stack, the same are often glued to the rotor lamination stack. Unfortunately, this process is technically complex and expensive. In addition, cracks may occur in the cured adhesive, and parts of the adhesive can drop off and damage the electrical machine, in particular caused by different thermal expansion coefficients of the rotor lamination stack, the rotor magnet and the adhesive. Further, the adhesive position is not the same in all scenarios. That does also mean that the known fixation of the rotor magnet is not very reliable.

### DISCLOSURE OF INVENTION

An object of the invention is to provide an improved rotor for an electric machine, an improved electric machine and an improved electric vehicle. In particular, a solution shall be proposed, which allows a reliable fixation of the rotor magnet in an easier way and can avoid damage of the electric machine by adhesive parts.

The object of the invention is solved by a rotor as disclosed in the opening paragraph, wherein
at least some of the rotor laminations comprise a spring tongue, which is unbent and reaches into a space provided for the rotor magnet in the unmounted state of the rotor magnet and which is bent and which imposes an oblique force on the same in the mounted state of the rotor magnet based on elastic deformation of the spring tongue, wherein
the oblique force is directed in an angle of 0°>α>90° to longitudinal sides of the rectangular cross section of the rotor magnet.

In particular, the rotor can have a plurality of cavities corresponding to said cavity for the rotor magnet, a plurality of rotor magnets corresponding to said rotor magnet and a plurality of spring tongues corresponding to said spring tongue, wherein one rotor magnet is arranged in one cavity each.

The spring tongue can be an extension or protrusion of the rotor lamination.

In addition, the object of the invention is solved by an electric machine, which comprises a stator and a rotor of the above kind, which is rotatably arranged relative to the stator.

Finally, the object of the invention is solved by a vehicle with a drivetrain comprising an electric machine as defined above, which is provided to propel the vehicle.

By use of the proposed measures, fixation of the rotor magnet can be achieved with a more cost-effective production process. Moreover, the fixation is very reliable because the spring tongue can compensate different thermal expansions of the rotor lamination stack and the rotor magnet as the spring tongue is a part of the rotor lamination stack. In detail, the fixation of the rotor magnet blocks a movement in five degrees of freedom. Basically, the rotor magnet can only be moved in axial direction, which movement however is hindered by a friction force generated by the spring tongue.

Further advantageous embodiments are disclosed in the claims and in the description as well as in the figures.

Beneficially, the spring tongue in the mounted state of the rotor magnet can be bent
a) in axial direction or
b) transversal to the axial direction (in particular perpendicular to the axial direction).

In case a), advantageously, a spring tongue may be made comparably broad. In case b), advantageously, a movement range of a spring tongue does not reach into an adjacent rotor lamination.

In particular, the spring tongue in case a)
A) can project in a projecting direction at an angle of 0°>α>90° to longitudinal sides of the rectangular cross section of the rotor magnet and can have an end, which is oriented perpendicular to its projecting direction (in particular, the projection direction may coincide with the direction of the oblique force), or
B) can project in a projecting direction parallel to one of the longitudinal sides of the rectangular cross section of the rotor magnet and can have an end, which is angled in view of the projecting direction, or
C) can project in a projecting direction at an angle α of 0°>α>90° to longitudinal sides of the rectangular cross section of the rotor magnet and can have an end, which is angled in view of the projecting direction.

In case A), a projecting direction and a bending axis of the spring tongue is angled in view of longitudinal sides of the rectangular cross section of the rotor magnet. Its right angled end contacts the rotor magnet on one of its corners and imposes the oblique force on said corner. In case B), a projecting direction and a bending axis of the spring tongue each are parallel to one of the longitudinal sides of the rectangular cross section of the rotor magnet. Nonetheless, the angled end of the spring tongue imposes the oblique force on a corner of the rotor magnet. Finally, case C) discloses a mixed embodiment having features of both embodiments A) and B) in common.

Beneficially, a rotor lamination of the rotor laminations may comprise
i) a single spring tongue imposing the oblique force on the rotor magnet or
ii) a plurality of spring tongues imposing forces on the rotor magnet including the oblique force.

In case i), production of the rotor laminations is comparably easy, whereas in case ii) the fixation of the rotor magnet is particularly reliable.

In yet another beneficial embodiment of the rotor, a rotor lamination of the rotor laminations comprises a leaf spring imposing an additional force on the rotor magnet which is directed in parallel with two of longitudinal sides of the rectangular cross section of the rotor magnet. In this way, fixation of the rotor magnet in the cavity can be further enhanced.

Beneficially, the spring tongue in the unbent state may have
I) a curved cross section or
II) a straight cross section.

In particular, a relevant cross sectional plane is oriented perpendicular to the bending direction of the spring tongue. That means that said cross sectional plane is oriented perpendicular to a plane of the rotor lamination in case a) and parallel to a plane of the rotor lamination in case b). By use of the measures disclosed in case I), the point where the spring tongue contacts the rotor magnet when the spring tongue is bent, can be influenced.

In an advantageous embodiment, all rotor laminations of the rotor lamination stack comprise the spring tongue. In this way, fixation of the rotor magnet in the rotor lamination stack is particularly reliable.

In a very advantageous embodiment of the rotor, all rotor laminations of the rotor lamination stack are identical. In this way, production of the rotor laminations can be done very cost-effective.

Advantageously, the oblique force generated by the spring tongue points radially outwards or has a radial component pointing outwards. In this way, an even higher force acts on the rotor magnet during operation of the electric machine because of the centrifugal force acting then. “Radial” in this context means pointing outwards from or in view of the rotor axis.

Advantageously, the rotor magnet is pressed into an outer corner of the cavity by the spring tongue. In this way, the rotor magnet is fixed within the cavity particularly well because on the one hand, five degrees of freedom are fixed thereby, and on the other hand, a centrifugal force acting during operation of the electric machine even further contributes to this effect.

Beneficially, the spring tongue can be formed by punching. In this way, the spring tongue can be manufactured comparable easy and cost-effective.

In addition, a gap between the rotor lamination stack and the rotor magnet can be filled with a potting compound. In this way, the rotor magnet ia fixed to the rotor lamination stack even better. Nevertheless, a cavity for the rotor magnet may also be kept free from a potting compound. In this way, the manufacturing of the rotor is easier and can be done more cost-effective.

### BRIEF DESCRIPTION OF DRAWINGS

The invention now is described in more detail hereinafter with reference to particular embodiments, which the invention however is not limited to.

FIG. 1 shows a sectional view of an exemplary electric machine;

FIG. 2 shows an oblique view of a rotor lamination stack;

FIG. 3 shows a detailed view of a rotor lamination stack with spring tongues projecting in a projecting direction angled to longitudinal sides of the rotor magnets;

FIG. 4 like FIG. 3 but with additional leaf springs;

FIG. 5 shows a detailed view of a rotor lamination stack with spring tongues having angled ends;

FIG. 6 shows a detailed view of a rotor lamination stack with spring tongues bending transversally to an axial direction;

FIG. 7 shows an axial sectional view of a part of an exemplary rotor lamination stack with a rotor magnet, wherein the spring tongues can move within a groove;

FIG. 8 like FIG. 7 but wherein the spring tongues can move within a recess;

FIG. 9 like FIG. 7 but wherein gaps between the rotor magnet and the rotor lamination stack are filled with a potting compound and

FIG. 10 shows a schematic view of an electric vehicle.

### DETAILED DESCRIPTION

Generally, same parts or similar parts are denoted with the same/similar names and reference signs. The features disclosed in the description apply to parts with the same/similar names respectively reference signs. Indicating the orientation and relative position is related to the associated figure.

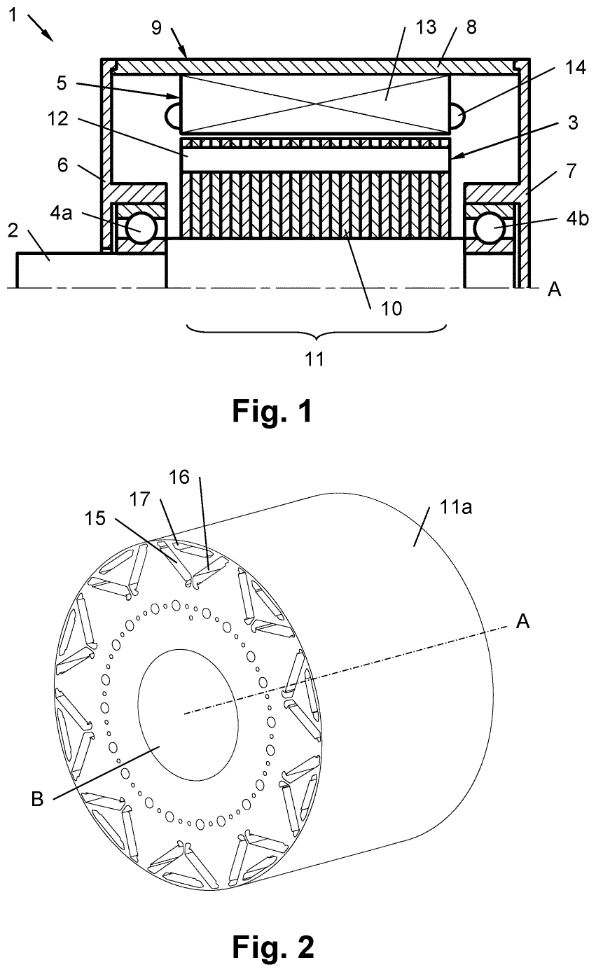

FIG. 1 shows a half section through a schematically drawn electric machine 1. The electric machine 1 comprises a rotor shaft 2 with a rotor 3 mounted thereon, wherein the rotor shaft 2 is rotatably supported around a rotor axis or rotation axis A relative to a stator 5 by means of a first and a second (rolling) bearing 4a, 4b. The first bearing 4a is mounted to a front bearing shield 6 and the second bearing 4b is mounted to a rear bearing shield 7. The electric machine 1 also comprises a middle housing part 8, which surrounds the stator 5 and connects the front bearing shield 6 and the rear bearing shield 7. The front bearing shield 6, the rear bearing shield 7 and the middle housing part 8 together form the housing 9 of the electric machine 1.

The rotor 3 has a rotor lamination stack 11 with a plurality of rotor laminations 10 stacked over another in an axial direction parallel to the rotor axis A, wherein the rotor laminations 10 form a cavity for a rotor magnet 12. Moreover, the electric machine 1 comprises a rotor magnet 12, which is arranged in said cavity. In addition, the stator 5 has a stator lamination stack 13 with stator windings 14 arranged therein.

FIG. 2 shows an example of a rotor lamination stack 11a in oblique view, which illustrates how a number of cavities 15, 16, 17 may be arranged around the rotation axis A. FIG. 2 additionally shows a shaft bore B for the rotor shaft 2.

FIG. 3 shows a detailed front view of a rotor lamination stack 11b, which is similar to the rotor lamination stack 11a of FIG. 2. In contrast, a rotor magnet 12a is arranged in a cavity 15a, a rotor magnet 12b is arranged in a cavity 16a and a rotor magnet 12c is arranged in a non-denoted cavity similar to the cavity 17 of FIG. 2.

At least some of the rotor laminations 10 comprise spring tongues 18a, 18a′, which are unbent and reach into a space provided for the rotor magnet 12a, 12b in the unmounted state of the rotor magnet 12a, 12b and which are bent and which impose oblique forces F1, F1′ on the same in the mounted state of the rotor magnets 12a, 12b based on elastic deformation of the spring tongues 18a, 18a′. The oblique forces F1, F1′ are directed in an angle α of 0°>α>90° to longitudinal sides of the rectangular cross section of the rotor magnets 12a, 12b.

In this embodiment, the spring tongues 18a, 18a′ are bent in axial direction (i.e. in a direction parallel to the rotation axis A) in the mounted state of the rotor magnets 12a, 12b. In detail, the spring tongues 18a, 18a′ each project in a projecting direction at an angle α of 0°>α>90° to longitudinal sides of the rectangular cross section of the rotor magnets 12a, 12b. In addition, the spring tongues 18a, 18a′ each have an end, which is oriented perpendicular to its projecting direction. In other words, a projecting direction and a bending axis of the spring tongues 18a, 18a′ is angled in view of longitudinal sides of the rectangular cross section of the rotor magnets 12a, 12b. Their right angled ends each contact the rotor magnets 12a, 12b on one of their corners and impose oblique forces F1, F1′ on the rotor magnets 12a, 12b. In particular, like this is the case in FIG. 3, the projection direction of the spring tongues 18a, 18a′ can coincide with the direction of the oblique forces F1, F1′. The forces F1, F1′ imposed on the rotor magnets 12a, 12b have radial components pointing outwards. However, the forces F1, F1′ could also point outwards radially (without having tangential component). As result, the oblique forces F1, F1′ cause the rotor magnets 12a, 12b being pressed into outer corners C, C′ of the cavities 15a, 16a. this way, a movement of the rotor magnets 12a, 12b within the cavities 15a, 16a is not only blocked in five degrees of freedom, but a centrifugal force acting on the rotor magnets 12a, 12b during operation of the electric machine 1 even further contributes to this effect.

Generally, the spring tongue 18a, 18a′ can be formed by punching, in particular during the same punching step, in which the rotor lamination 10 is fabricated.

Generally, some of the or all rotor laminations 10 of the rotor lamination stack 11, 11a, 11b may be equipped with spring tongues 18a, 18a′. In case that all rotor laminations 10 comprise spring tongues 18a, 18a′, fixation of the rotor magnets 12a, 12b in the rotor lamination stack 11b is particularly reliable.

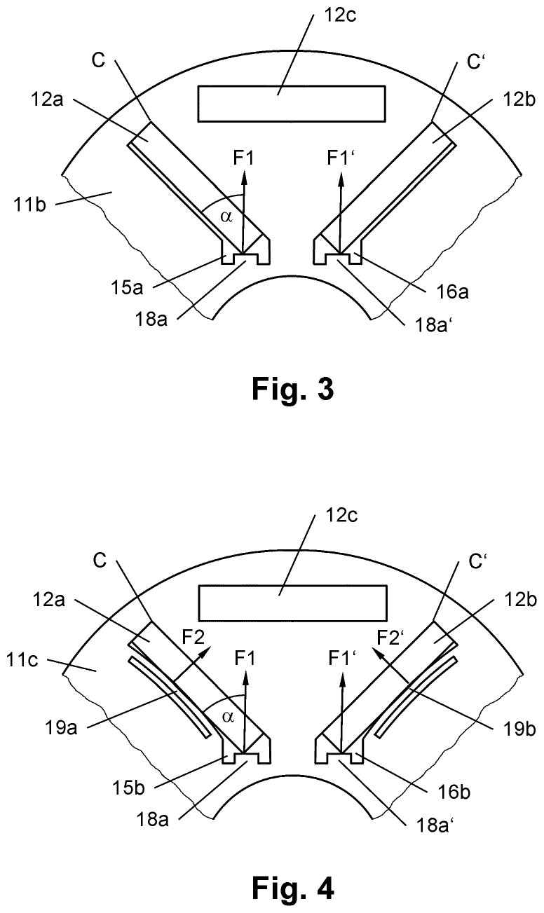

FIG. 4 shows a rotor lamination stack 11c, which is similar to the rotor lamination stack 11b shown in FIG. 3. In contrast, a couple of the or all rotor laminations 10 of the rotor lamination stack 11c comprise leaf springs 19a, 19b, which impose additional forces F2, F2′ on the rotor magnets 12a, 12b. The forces F2, F2′ are directed in parallel with two of longitudinal sides of the rectangular cross sections of the rotor magnets 12a, 12b. In this way, fixation of the rotor magnets 12a, 12b in the cavities 15a, 16a can be further enhanced. The leaf springs 19a, 19b are formed here by slits arranged beneath.

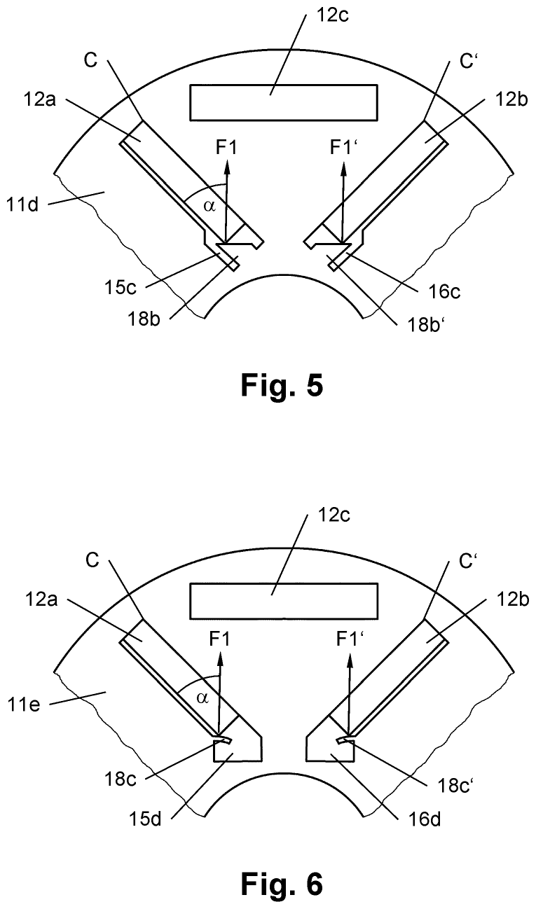

FIG. 5 shows another rotor lamination stack 11d, which is similar to the rotor lamination stack 11b shown in FIG. 3. In contrast, spring tongues 18b, 18b′ each project in a projecting direction parallel to one of the longitudinal sides of the rectangular cross sections of the rotor magnets 12a, 12b and have an end, which is angled in view of the projecting direction. In this case, bending axes of the spring tongues 18b, 18b′ are each parallel to one of the longitudinal sides of the rectangular cross sections of the rotor magnets 12a, 12b. Nonetheless, the angled ends of the spring tongues 18b, 18b′ impose oblique forces F1, F1′ on the rotor magnets 12a, 12b. Again, the spring tongues 18b, 18b′ are bent in axial direction (i.e. in a direction parallel to the rotation axis A) in the mounted state of the rotor magnets 12a, 12b in this embodiment and again, the oblique forces F1, F1′ cause the rotor magnets 12a, 12b being pressed into outer corners C, C′ of the cavities 15a, 16a. In this way, a movement of the rotor magnets 12a, 12b within the cavities 15a, 16a is not only blocked in five degrees of freedom, but a centrifugal force acting on the rotor magnets 12a, 12b during operation of the electric machine 1 even further contributes to this effect.

It should be noted that mixed embodiments, comprising features of FIG. 3 and features of FIG. 5 are possible as well. In this case, the spring tongues 18b, 18b′ would project in a projecting direction at an angle α of 0°>α>90° to longitudinal sides of the rectangular cross sections of the rotor magnets 12a, 12b and would have ends, which are angled in view of the projecting direction.

FIG. 6 shows yet another rotor lamination stack 11e, which is similar to the rotor lamination stack 11b shown in FIG. 3. In contrast, the spring tongues 18c, 18c′ in the mounted state of the rotor magnets 12a, 12b are bent transversal to the axial direction, here in particular perpendicular to the axial direction (i.e. transversal or perpendicular to the rotation axis A). By use of transversally bending spring tongues 18c, 18c′, a movement of the spring tongues 18c, 18c′ into adjacent rotor laminations 10 can be avoided. So, this measure allows an embodiment, where all rotor laminations 10 of the rotor lamination stack 11e are identical.

As is conceivable from FIG. 2, the rotor lamination stacks 11, 11a . . . 11e of FIGS. 1 and 3 to 6 generally can comprise a plurality of cavities 15a . . . 16d, a plurality of rotor magnets 12, 12a . . . 12c and a plurality of spring tongues 18a . . . 18c′, wherein one rotor magnet 12, 12a . . . 12c is arranged in one cavity 15a . . . 16d each. As is visible in FIG. 2, the plurality of cavities 15 . . . 17 can symmetrically be arranged around the rotation axis A.

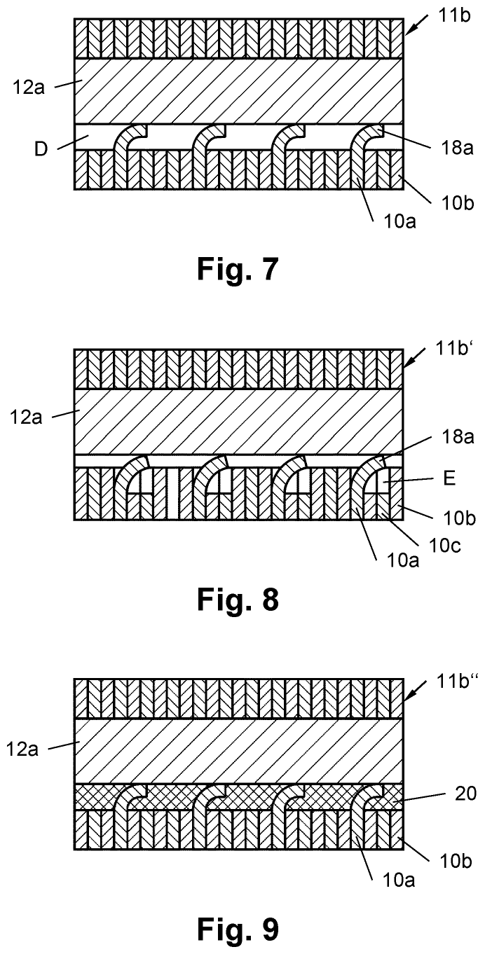

FIG. 7 shows an axial sectional view of the upper part of an exemplary rotor lamination stack 11b. Here, different rotor laminations 10a and 10b are used. The rotor laminations 10a are equipped with springs tongues 18a, the rotor laminations 10b are not. As is visible, the spring tongues 18a are bent and impose a force on the rotor magnet 12a in the mounted state of the rotor magnet 12a based on elastic deformation of the spring tongues 18a. In detail, the spring tongues 18a move into the groove D when they are bent.

FIG. 8 shows an example of a rotor lamination stack 11b′, which is similar to the rotor lamination stack 11b of FIG. 7. In contrast, a rotor magnet 12a is arranged in a cavity, which provides recesses E for the bent spring tongues 18a formed by rotor laminations 10c. In this way, a gap between the rotor lamination stack 11b′ and the rotor magnet 12a can be kept small.

FIG. 9 shows another example, where gaps between the rotor lamination stack 11b″ and the rotor magnet 12a are filled with a potting compound 20. In this way, the rotor magnets 12a are fixed to the rotor lamination stack 11b″ even better.

Generally, a plurality of spring tongues 18a . . . 18c′ per rotor lamination 10, 10a can impose oblique forces F1, F1′ on the rotor magnets 12, 12a, 12b. Alternatively, also a single spring tongue 18a . . . 18c′ per rotor lamination 10, 10a can be provided for imposing the oblique forces F1, F1′ on the rotor magnets 12, 12a, 12b.

Generally, the spring tongues 18a . . . 18c′ in the unbent state may have a straight cross section or a curved cross section. Spring tongues 18a . . . 18c′ with straight cross section are easy to produce and can be made comparably broad. By use of curved spring tongues 18a . . . 18c′, the point where the spring tongue 18a . . . 18c′ contacts the rotor magnet 12, 12a, 12b when the spring tongue 18a . . . 18c′ is bent, can be influenced.

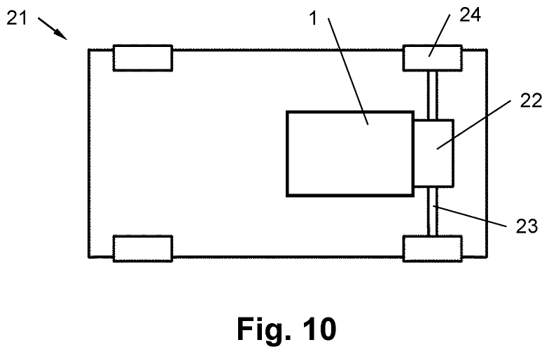

FIG. 10 finally shows an electric vehicle 21 with a drivetrain comprising an electric machine 1 as defined hereinbefore, which is provided to propel the electric vehicle 21. In detail, the electric machine 1 is coupled to gearbox 22, side shafts 23 and finally to the wheels 24. The electric machine 1 may be provided for powering the electric vehicle 21 permanently in a pure electric car or intermittently, e.g. in combination with a combustion engine in a hybrid car.

It is noted that the invention is not limited to the embodiments disclosed hereinbefore, but combinations of the different variants are possible. In reality, the electric machine 1 and the electric vehicle 21 may have more or less parts than shown in the figures. It is also noted that the electric machine 1 and the electric vehicle 21 or parts thereof are not necessarily drawn to scale in the FIGS. Moreover, the description may comprise subject matter of further independent inventions.

It should also be noted that the term “comprising” does not exclude other elements and the use of articles “a” or “an” does not exclude a plurality. Also elements described in association with different embodiments may be combined. It should also be noted that reference signs in the claims should not be construed as limiting the scope of the claims.

### LIST OF REFERENCES

1 electric machine
2 rotor shaft
3 rotor
4a, 4b (rolling) bearing
5 stator
6 front bearing shield
7 rear bearing shield
8 (middle) housing part
9 housing
10, 10a . . . 10c rotor lamination
11, 11a . . . 11e rotor lamination stack
12, 12a . . . 12c rotor magnet
13 stator lamination pack
14 stator winding
15, 15a . . . 15d (first) cavity/compartment for rotor magnet
16, 16a . . . 16d (second) cavity/compartment for rotor magnet
17, 17a . . . 17d (third) cavity/compartment for rotor magnet
18a . . . 18c′ spring tongue
19a, 19b leaf spring
20 potting compound
21 vehicle
22 gear
23 side shaft
24 wheel
A rotor axis/rotation axis
B shaft bore
C, C corner
D groove (deepening)
E recess (deepening)
F1, F1′ oblique force
F2, F2′ additional force caused by leaf spring
α angle

1. Rotor for an electric machine, comprising
a rotor lamination stack with a plurality of rotor laminations stacked over one another in an axial direction, wherein the rotor laminations form a cavity for a rotor magnet, and
a rotor magnet, which is arranged in said cavity and which has a substantially rectangular cross section,
wherein
at least some of the rotor laminations comprise a spring tongue, which is unbent and reaches into a space provided for the rotor magnet in the unmounted state of the rotor magnet and which is bent and which imposes an oblique force on the same in the mounted state of the rotor magnet based on elastic deformation of the spring tongue, wherein
the oblique force is directed in an angle of 0°>α>90° to longitudinal sides of the rectangular cross section of the rotor magnet.

2. Rotor as claimed in claim 1, wherein the spring tongue in the mounted state of the rotor magnet is bent
a) in axial direction or
b) transversal to the axial direction.

3. Rotor as claimed in claim 2, wherein the spring tongue in case a)
A) projects in a projecting direction at an angle (α) of 0°>α>90° to longitudinal sides of the rectangular cross section of the rotor magnet and has an end, which is oriented perpendicular to its projecting direction, or
B) projects in a projecting direction parallel to one of the longitudinal sides of the rectangular cross section of the rotor magnet and has an end, which is angled in view of the projecting direction, or
C) projects in a projecting direction at an angle α of 0°>α>90° to longitudinal sides of the rectangular cross section of the rotor magnet and has an end, which is angled in view of the projecting direction.

4. Rotor as claimed in claim 1, wherein a rotor lamination of the rotor laminations comprises
i) a single spring tongue imposing the oblique force on the rotor magnet or
ii) a plurality of spring tongues imposing forces on the rotor magnet including the oblique force.

5. Rotor as claimed in claim 1, wherein a rotor lamination of the rotor laminations comprises a leaf spring imposing an additional force on the rotor magnet which is directed in parallel with two of longitudinal sides of the rectangular cross section of the rotor magnet.

6. Rotor as claimed in claim 1, wherein the spring tongue in the unbent state has
I) a curved cross section or
II) a straight cross section.

7. Rotor as claimed in claim 1, wherein all rotor laminations of the rotor lamination stack comprise a spring tongue.

8. Rotor as claimed in claim 1, wherein all rotor laminations of the rotor lamination stack are identical.

9. Rotor as claimed in claim 1, wherein the oblique force points radially outwards or has a radial component pointing outwards.

10. Rotor as claimed in claim 1, wherein the rotor magnet is pressed into an outer corner of the cavity by the spring tongue.

11. Rotor as claimed in claim 1, wherein the spring tongue is formed by punching.

12. Rotor as claimed in claim 1, wherein a gap between the rotor lamination stack and the rotor magnet is filled with a potting compound.

13. Rotor as claimed in claim 1, wherein a plurality of cavities corresponding to said cavity for the rotor magnet, a plurality of rotor magnets corresponding to said rotor magnet and a plurality of spring tongues corresponding to said spring tongue, wherein one rotor magnet is arranged in one cavity each.

14. Electric machine, comprising
a stator and
a rotor according to claim 1, which is rotatably arranged relative to the stator.

15. Vehicle with a drive train comprising an electric machine according to claim 14, which is provided to propel the vehicle.

16. Rotor as claimed in claim 2, wherein a rotor lamination of the rotor laminations comprises
i) a single spring tongue imposing the oblique force on the rotor magnet or
ii) a plurality of spring tongues imposing forces on the rotor magnet including the oblique force.

17. Rotor as claimed in claim 2, wherein a rotor lamination of the rotor laminations comprises a leaf spring imposing an additional force on the rotor magnet which is directed in parallel with two of longitudinal sides of the rectangular cross section of the rotor magnet.

18. Rotor as claimed in claim 2, wherein the spring tongue in the unbent state has
I) a curved cross section or
II) a straight cross section.

19. Rotor as claimed in claim 2, wherein all rotor laminations of the rotor lamination stack comprise a spring tongue.

20. Rotor as claimed in claim 2, wherein all rotor laminations of the rotor lamination stack are identical.
